(19) United States
(12) Patent Application Publication
(10) Pub. No.: US 2025/0237506 A1
(43) Pub. Date: Jul. 24, 2025

(54) LOCATION FINDING APPARATUS AND ASSOCIATED METHODS

(71) Applicant: Waymap Ltd., London (GB)

(72) Inventors: Tim MURDOCH, London (GB); Paul Daniel BAXTER, London (GB); Douglas O'ROURKE, London (GB)

(73) Assignee: Waymap Ltd., London (GB)

(21) Appl. No.: 18/703,399

(22) PCT Filed: Oct. 21, 2022
(86) PCT No.: PCT/GB2022/052699

§ 371 Date: Apr. 22, 2024

(30) Foreign Application Priority Data
Oct. 22, 2021 (GB) 2115256.6

(51) Int. Cl. G01C 21/16; G01C 21/20

(52) U.S. Cl. CPC G01C 21/16; G01C 21/206

(57) ABSTRACT

The present disclosure relates to a method of estimating a location of a device, the method comprising: obtaining information indicating an initial location of the device; obtaining data indicating a movement of the device; obtaining information corresponding to an expected path of the device; determining, using the data indicating the movement of the device, a set of candidate locations of the device, and assigning each candidate location a corresponding weight using the information corresponding to the expected path of the device; and determining an estimated location of the device using the set of candidate locations and the corresponding weights.

### FIELD OF THE INVENTION

The present invention relates to location finding. The invention has particular although not exclusive relevance to location finding apparatus, personal navigation, and associated apparatus and methods for location finding and tracking where conventional location finding apparatus, such as global positioning system (GPS) technology, or the like cannot be used effectively (e.g. indoors, underground or the like).

### BACKGROUND TO THE INVENTION

It is now commonplace for mobile telephones, wearable electronics, and other portable computational devices to include location finding and related features, such as Global Positioning System (GPS) for tracking a user's position, and compasses in the form of magnetometers for direction finding. However, conventional location finding technology, such as GPS positioning, can be unreliable in some situations, in particular in environments where GPS signals cannot be received properly such as indoors, underground or in heavily forested areas. This can lead to situations where little or no location information can be derived for a user.

This issue is compounded by the many applications in which accurate location finding and/or tracking would be desirable in scenarios where the conventional location finding technology cannot be used with sufficient accuracy. One such application, for example, is the tracking of a device within a building or other GPS impaired location for the purposes of security, personnel or goods tracking, time-in-motion analysis and/or the like, in order to acquire information on current location, previous places visited, time spent in certain locations, etc.

Furthermore, in order to maintain accurate position tracking using conventional GPS technology, a relatively significant amount of energy is needed. This is a particular issue for portable devices such as mobile telephones, in which it is important to keep energy usage as low as possible in order to preserve battery life. Therefore, it would be advantageous, even when a good GPS signal is available, to be able to reduce the frequency with which a GPS fix would need to be obtained.

One technique for determining position in situations where conventional positioning technology cannot be used, or in which such use is undesirable, is so called ‘dead reckoning’ or ‘ded (‘deduced’) reckoning’ in which a previously ‘known’ position or ‘fix’ is used in combination with estimates of distance and direction travelled in order to estimate a current position. For example, inertial sensors (INS) of the sort commonly integrated into modern ‘smart’ devices including cellular phones (such as gyroscopes, multi-axis accelerometers, or the like) can be used to provide, at a relatively low cost, motion data required for estimating indoor location. However, a significant limitation of such inertial sensing based dead reckoning is that the sensor measurements can be noisy and errors accumulate in the process of integrating the measured quantities to obtain the desired positional measurements (i.e. effectively integrating acceleration twice to obtain displacement and hence position).

Many existing solutions for indoor tracking therefore rely on some component of infrastructure, such as a ranging beacon, or knowledge of radio signal distribution from external infrastructure (e.g. cellular base stations) in the building, to alleviate this accumulation of error. This increases the cost and time required to set up such a system. Furthermore, there is the risk that elements of that infrastructure, such as the radio signal distribution, will change over time causing the associated positioning calculations to drift and hence a requirement for semi-regular re-calibration.

Other existing methodologies which make use of inertial data do so in a way which does not address the accumulation of error in inertial sensing. This may limit the applicability of such methods when deployed in realistic scenarios.

### SUMMARY OF THE INVENTION

The present invention seeks to provide a portable device for tracking the location of a user and associated methods and programs for addressing or at least partially ameliorating one or more of the above issues.

Aspects of the invention are recited in the appended independent claims.

In a first aspect the invention provides a method of estimating a location of a device, the method comprising: obtaining information indicating an initial location of the device; obtaining data indicating a movement of the device; obtaining information corresponding to an expected path of the device; determining, using the data indicating the movement of the device, a set of candidate locations of the device, and assigning each candidate location a corresponding weight using the information corresponding to the expected path of the device; and determining an estimated location of the device using the set of candidate locations and the corresponding weights.

Determining the estimated location of the device may comprise calculating a weighted average of the set of candidate locations. The weighted average may be obtained by calculating an arithmetic mean, a geometric mean or a harmonic mean.

The expected path may correspond to a route to an expected destination of the device. The expected destination may be input into the device by a user.

The expected path may be determined based on information indicating areas travelled through by other users. The expected path may be determined based on information indicating areas travelled through by other users when the other users are navigating to destinations within a threshold distance of the expected destination.

The method may further comprise: iteratively updating the set of candidate locations and the corresponding weights; and updating the estimated location of the device using the updated set of candidate locations and the corresponding weights.

The method may further comprise reducing the weight of a candidate location that corresponds to the device departing from the expected path.

The method may further comprise obtaining mapping data that indicates a plurality of spatial zones; and the information corresponding to the expected path of the device may indicate a sequence of the spatial zones that corresponds to at least part of the expected path. The sequence of spatial zones may be a contiguous sequence of spatial zones.

The mapping data may include, for each of the spatial zones in the sequence, a corresponding sequence identifier that identifies the position of the spatial zone in the sequence.

The method may further comprise storing, when a candidate location falls within a spatial zone of the sequence, that candidate location in association with the corresponding sequence identifier of that spatial zone.

The method may further comprise storing, when a candidate location corresponds to the device leaving the expected path from a spatial zone in the sequence, information identifying the spatial zone from which the device left the path, in association with the candidate location.

The mapping data may comprise: for at least some of the spatial zones, a corresponding weighting factor for reducing or increasing the weight of a candidate location that corresponds to the device moving into that spatial zone.

The mapping data may comprises: for at least one of the spatial zones, a corresponding weighting factor for reducing the weight of a candidate location that corresponds to the device departing the expected path by moving out of that spatial zone; or for at least one of the spatial zones, a corresponding weighting factor for reducing the weight of a candidate location that corresponds to the device departing the expected path by moving into that spatial zone.

The method may further comprise reducing the weight of a candidate location that corresponds to the device departing the expected path using a global weighting parameter.

The method may further comprise: reducing the weight of a candidate location that corresponds to the device moving from a first spatial zone of the spatial zones that form the expect path to a second spatial zone of the spatial zones that form the expected path, when a difference between the sequence identifier stored in association with the first spatial zone and the sequence identifier stored in association with the second spatial zone exceeds a predetermined threshold value.

The method may further comprise increasing the weight of a candidate location that corresponds to the device re-joining the expected path.

The method may further comprise: obtaining information indicating the location of walls of a building; determining whether a candidate location corresponds to the device moving through a wall of the building; and reducing the weight of a candidate location that corresponds to the device moving through a wall of the building.

The information indicating a movement of the device may include data obtained from at least one sensor of the device.

The information indicating a movement of the device may include data obtained from a gyroscope, accelerometer, magnetometer, or pressure sensor of the device.

The method may further comprise using the estimated location of the device for guided navigation along the expected route.

The method may further comprise: obtaining information corresponding to an expected heading of the device; and determining the weights using the information corresponding to the expected heading of the device.

The method may further comprise: increasing the weight of candidate locations that correspond to the device having a heading that is within a predetermined angular range of the expected heading; or decreasing the weight of candidate locations that correspond to the device having a heading that is not within a predetermined angular range of the expected heading.

The method of estimating the location of the device may comprise a particle filter method. The method of estimating the location of the device may comprise a Gaussian Mixture PHD filter method.

The method of estimating the location of the device may comprise a sequential Monte Carlo method.

The method may further comprise: obtaining user characteristic information indicating a step length or step frequency of the user; and determining the candidate locations using the obtained user characteristic information.

In a second aspect the invention provides a computer-readable medium comprising instructions which, when executed by a computer, cause the computer to carry out the method of the first aspect.

In a third aspect the invention provides apparatus for estimating a location of a device, wherein the apparatus comprises: means for obtaining information indicating an initial location of the device; means for obtaining data indicating a movement of the device; means for obtaining information corresponding to an expected path of the device; means for determining, using the data indicating the movement of the device, a set of candidate locations of the device, and for assigning each candidate location a corresponding weight using the information corresponding to the expected path of the device; and means for determining an estimated location of the device using the set of candidate locations and the corresponding weights.

The expected path may correspond to a route to an expected destination of the device. The expected destination may be input into the device by a user.

The means for obtaining information indicating an initial location of the device; means for obtaining data indicating a movement of the device; means for obtaining information corresponding to an expected path of the device; means for determining, using the data indicating the movement of the device, a set of candidate locations of the device, and for assigning each candidate location a corresponding weight using the information corresponding to the expected path of the device; and means for calculating a weighted average of the set of candidate locations to determine an estimated location of the device may be located in a single device, or may be distributed amongst a plurality of devices. For example, the apparatus may comprise the device and a remote server.

The means for obtaining data indicating a movement of the device may be provided in the device. The means for determining, using the data indicating the movement of the device, a set of candidate locations of the device, and for assigning each candidate location a corresponding weight using the information corresponding to the expected path of the device, and the means for calculating a weighted average of the set of candidate locations to determine an estimated location of the device, may be provided remotely from the device (for example, as a remote server).

Beneficially, the apparatus of the present disclosure utilises information comprising an intended path of a user to predict the location of the user. This enables a more accurate estimation of the location of the user to be determined, and enables a wider range of user behaviour to be taken into account to provide more reliable and robust location estimates.

In a particularly advantageous example, an expected heading of the user is also taken into account. Beneficially, therefore, the accuracy of the estimation of the location of the user is improved by taking into account that the heading of the user is likely to fall within a predetermined range of headings if the user is following the intended path.

### BRIEF DESCRIPTION OF THE DRAWINGS

Embodiments of the invention will now be described by way of example only with reference to the attached figures in which:

FIG. 1 schematically illustrates a location system;

FIG. 2 schematically illustrates operation of the indoor system of FIG. 1 whilst tracking a journey through a building;

FIG. 3 schematically illustrates apparatus for use in the location system of FIG. 1 to track a journey through a building such as that illustrated in FIG. 2;

FIG. 4 is a simplified flow chart illustrating operation of the apparatus of FIG. 2 to classify motion;

FIG. 5 is a simplified flow chart illustrating operation of the apparatus of FIG. 2 to provide position estimates;

FIG. 6 is a simplified flow chart illustrating, in more detail, operation of the apparatus of FIG. 2, during part of the process of FIG. 5 to update a particle set and perform a position estimate;

FIG. 7 shows a simplified schematic illustration of an expected path of a user through a plurality of polygonal areas;

FIG. 8 shows a simplified schematic illustration of a deviation from the expected path by the user, in which the user returns to the expected path;

FIG. 9 shows a simplified schematic illustration of a deviation from the expected path by the user, in which the user does not return to the expected path;

FIG. 10 shows a simplified schematic illustration in which the user returns to the intended path, but further along the path than expected;

FIG. 11 shows a simplified schematic illustration of a number of particle positions distributed within the polygonal areas;

FIG. 12 shows a simplified schematic illustration of an intended path of a user through a plurality of polygonal areas; and

FIG. 13 shows a simplified schematic illustration of particle heading information.

### DETAILED DESCRIPTION

A portable device for tracking the location of a user carrying the device is described by way of example with reference to the drawings. The portable device generates a particle set comprising a plurality of particles each particle representing a respective estimate of a candidate state of the portable device, wherein the estimated candidate state comprises an estimated position of the portable device. Movement of the portable device is detected and analysed to estimate distance travelled by the device and to determine an estimated direction of movement of the device and the particle set is updated to reflect an estimated change in position represented by the estimated distance travelled by the device, and the estimated direction of movement of the device.

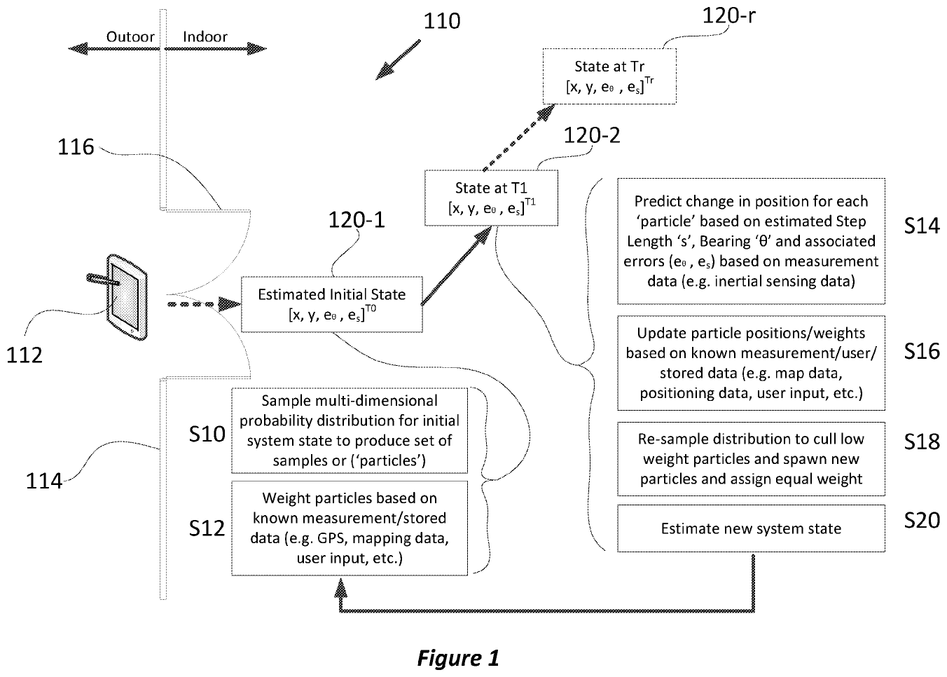

FIG. 1 schematically illustrates a location system generally at 110. The location system 110 comprises a location tracking device 112 that is configured for maintaining a position estimate for the location tracking device 112 and tracking its position as it moves through a location in which other forms of location derivation (such as global position system (GPS) location derivation, base cellular station trilateration, or the like) are not possible or not particularly effective. It will be appreciated, however, that the technique for maintaining a position estimate of the device can be used beneficially to supplement other forms of derivation if needed.

In the example illustrated in FIG. 1, the location tracking device 112 is shown moving from an external, or ‘outdoor’, location into an internal, or ‘indoor’, location in a building 114 via a door 116. The location tracking device 112 begins its ‘internal’ journey inside the building (at time=T0) at a first location 120-1 before moving to a second location (at time=T1), and then one or more further locations (at time=Tr) at 120-r.

The location tracking device 112, in this example, is configured to be carried by a human user. The location tracking device 112 uses inertial sensors to produce motion data for the device 112 as the user of the device 112 moves through the building 114. The location tracking device 112 determines an estimate of the speed and azimuth bearing (‘0’) of the movement of the device 112 based on the motion data and produces position estimates for the device 112 based on the estimated speed and azimuth bearing.

The location tracking device 112 classifies motion and produces estimates of the speed of the device based on pre-existing knowledge about human motion characteristics. This knowledge is used to derive more accurate motion information than simple use of the inertial sensors to produce an estimated speed and direction would normally allow. The pre-existing knowledge about human motion characteristics may be in the form of one or more motion profiles including, for example, information representing an average step length (‘s’), possibly for each of a plurality of different inertial characteristics associated with a respective different step type (e.g. walking/running/climbing or descending stairs or ramps etc.). The pre-existing knowledge about human motion characteristics may also comprise one or more motion profiles representing movement that can be ignored such as, for example, movement indicative of non-movement related user handling (or mishandling) of the device 112. Each motion profile is, itself, refined dynamically (‘on the fly’) if information from other data sources indicates that the motion profile does not precisely match the motion characteristics of the current user of the device. In effect, therefore, the device 112 is able to ‘self-learn’ by configuring itself more and more closely to the motion characteristics of a particular user as the motion profile(s) for that user become more accurate. This helps to reduce the build-up systematic errors in the position estimates, as the device moves through the building. In order to improve the motion classification and associated measurements, the device 112 employs Bayesian statistical data fusion techniques. These techniques allow improved extraction of information from noisy data sources.

The location tracking device 112 refines its position estimates using a particle filtering technique (also known as a ‘Sequential Monte Carlo’ (SMC) technique) that is enhanced to help reduce further the build-up of systematic errors in the position estimates, as the device moves through the building. Particle filtering is a technique for estimating a state that changes over time using a sequence of potentially noisy measurements. It works by approximating the probability distribution for the state by a set of particles.

The particle filtering technique of this example advantageously uses a multi-dimensional ‘state-space’ with system states that represent an estimated position of the user, and may also represent an estimate of the errors in the motion measurements that resulted in that estimated position. In the illustrated example, the particle filtering technique uses a four-dimensional dimensional ‘state-space’ (rather than a simple two-dimensional state-space), for movement in two-dimensions (i.e. on substantially the same level), with each ‘state’ being represented by a position in an east-west direction (‘x’), a position in a north-south direction (‘y’), a bearing error (‘e_{θ}’) and a step length error (‘eₛ’). However, in some examples described in more detail later, the bearing error and step length error need not necessarily be included. The state space may be enhanced, for example to take account of movement in three dimensions with each state represented by the ‘x’ position, the ‘y’ position, a position in the up-down direction (‘z’) (and optionally a bearing error (‘e_{θ}’), a step length error (‘eₛ’), and an altitude change error (‘eₐ’)).

When the system state contains the location of the user and the main systematic sources of error, the particle filter is advantageously able to estimate the location of the device 112 (the quantity of interest) whilst simultaneously estimating and correcting for the error sources which are most likely to degrade performance.

Beneficially, as will be described in more detail later, in a particularly advantageous embodiment the particle filtering technique also uses information regarding an intended path of the user to improve the accuracy and reliability of predictions of the location of the user. The particle filtering technique may also use information regarding an expected heading of the user along the intended path to further improve the accuracy and reliability of the predictions of the location of the user. It will be appreciated that these embodiments may be used with the particle filtering technique either with or without using (or including) the additional error parameters in the state space.

As illustrated in FIG. 1, in this example, at Time T0 when the user first enters the building a particle distribution for an estimated initial state ([x, y, e_{θ}, eₛ]^{T0}) is determined based on an estimated initial position 120-1 derived from pre-existing knowledge of the user's position immediately prior to entry to the building. This determination is triggered by an event such as, for example: a loss of a conventional positioning capability (e.g. GPS/base station trilateration); a user input (e.g. pressing a button on the device 112); and/or the device entering a pre-defined geographic zone as determined by the conventional positioning capability. The pre-existing knowledge of the user's position may comprise an estimated position determined by the conventional positioning capability; a position derived from stored mapping data (e.g. a known position of the entrance door 116); and/or the like.

A multi-dimensional probability density function associated with the estimated initial position (e.g. based on a known error distribution associated with the conventional positioning capability) is sampled to produce a set of candidate states for the estimated initial position where each candidate state is treated as a distinct particle (S10). Each particle is weighted, in this initial state, according to the probability associated with that particle from the probability density function (S12) taking account of any pre-existing knowledge about the initial position or the measurements from which the initial position was estimated (e.g. mapping data defining a known position of the entrance door 116 and/or uncertainty levels/error distributions associated with a conventional positioning measurement). The sum of all weights attributed to all particles is equal to unity.

When the device 112 moves to the second location 120-2 the device 112 is able to detect and classify the movement from the motion data output from the inertial sensors. The device 112 is able to use this motion data to determine each time a step has been taken by a user of the device which, in combination with a motion profile representing an expected average step length (‘s’), allows the distance moved to be estimated. The device 112 is also able to determine, from the motion data output from the inertial sensors, an estimated bearing (‘θ’). Thus, the device 112 is able to predict a change in position for each particle based on the estimated step length (‘s’), bearing (‘θ’) and associated error estimates (e_{θ}, eₛ) based on the inertial sensing data (S14).

The device 112 updates (at S16) the respective weight of each particle based on any available measurement data (including measurement data from conventional positioning features if available) and/or data entered by a user such as a room identifier. Advantageously, even where such measurement/user data is not available, the device 112 is still able to make inferences about the likelihood that the movement of a particular particle and hence its current position is genuine based on stored mapping and/or other data for the building 114 (or other location) in which the device 112 is being used. For example, mapping data derived from an image of the building plan can be used as additional information to constrain possible user routes through the building and help to prevent accumulation of errors. If a particle is found to have passed through an obstacle represented by such mapping data, such as a wall or item of fixed furniture, the particle's weight can be reduced to zero (or near zero) to indicate that that particle is very unlikely to represent the true position of the device 112. Similarly, if a particle is found to take a lower probability route (e.g. very close to the edge of a doorway rather than through its centre) then its weight can be reduced commensurately. The device 112 is also able to update a particle by adjusting the position and/or errors (state) associated with that particle to move it to a state that is more likely to be correct (this can be instead of, or in addition to, adjusting its weight).

Beneficially, a Bayesian statistical framework is used that allows the integration of multiple, potentially disparate types of information, for example allowing the same algorithm to make use of the information in GPS data, user inputs or other radio signals if any of these are available.

In more detail, the Bayesian statistical framework (and the Bayesian statistical data fusion techniques referred to earlier) employed involves the application of Bayes rule to calculate the probability distribution of quantities of interest from a given set of measurements. Different types of measurement (e.g. GPS, inertial data, wi-fi signal) have different noise characteristics and Bayes rule is used to incorporate the information in each measurement according to its noise characteristics balanced against the existing weight of information. For reasons of clarity and succinctness, Bayes rule (or ‘Bayes Theorem’) are not described here in detail but are well documented in scientific and public literature and will be well known to those skilled in the art.

To avoid unnecessary processing power being expended tracking particles that have a low weight, the modified probability density represented by the re-weighted particle distribution is re-sampled to remove low weight particles and to spawn new particles having a state close to that of the highest weight particles (at S18). The new ‘re-sampled’ particle set resulting from the re-sampling process has the same overall number of particles as were included in the old set of particles. Each particle in the re-sampled particle set is then assigned a new, equal, weight whilst maintaining the unity sum of all particle weights (hence the weight of each particle is equal to the reciprocal of the number of particles in the particle set).

The updated particle set is used (at S20) to determine a state estimate [x, y, e_{θ}, eₛ]^{T1} for the second location 120-2 by calculating, in this example, the mean over the set of particles. The mean may be an arithmetic mean, a geometric mean, or a harmonic mean. A measure of covariance can also be determined directly from the updated particle set in a straightforward way.

It will be appreciated that more sophisticated state summaries, which take into account the possibility of multi-modal distributions, may also be taken into account when the state estimate is determined.

This process is, in effect, repeated on a regular basis as the device 112 is carried around the building via each subsequent location 120-r.

Each estimated state is stored for subsequent download (or possibly concurrent download if appropriate communication features are available such as Wi-Fi, Bluetooth or the like) to determine the journey taken by the device. Beneficially, when the particle set for a later system state is refined based on the mapping data and any external sources of measurement data that may, intermittently, become available (e.g. GPS), the previously estimated earlier ‘historic’ states are also refined, based on the acquired knowledge represented by the newly refined particle set. This allows the overall journey taken by the device 112 to be represented, in memory, with increasing accuracy as the journey progresses. Hence, even when a real-time estimate of the system state has significant inaccuracies, these inaccuracies can be reduced significantly, or even eliminated, based on subsequent refinements made using inferences from the mapping data or external sources of measurement data.

It can be seen, therefore, that in this example the ‘map matching’ or particle filter applied here advantageously keeps track not only of the position, but also the causes of the accumulation of error in position. In this way, using the map, or other available information, it is possible to estimate the errors in step length and heading in order to arrest the accumulation of error.

For example, if a user of the device 112 is walking along a long corridor and the apparent user direction of heading implied they were drifting towards one or other of the walls at an angle of 5° then the map matched particle filtering allows the device to “learn” that the direction of heading has a 5° error. In a similar way, information from the map can be used to refine the step length used for predicting the movement of that user without having direct knowledge of the user's height or other information from which step length can be determined directly.

Thus, it can be seen that the above techniques can be combined through a map-matched particle filtering approach with motion analysis and classification with the potential to make inertial-only indoor tracking technically feasible in a much wider range of applications.

### Exemplary Journey

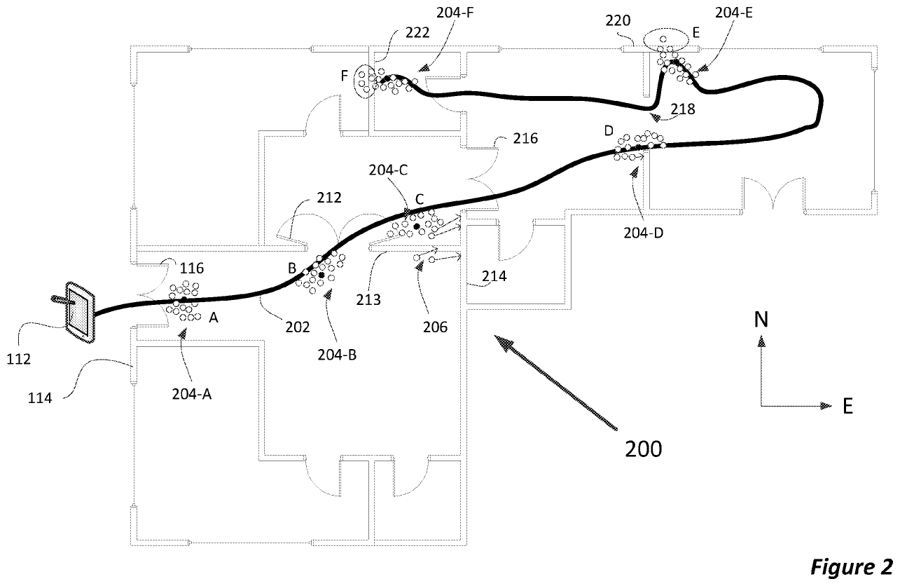

FIG. 2 illustrates, generally at 200, an exemplary journey 202 of the device 112 through a building, and in particular the refinement of a particle set 204-A to 204-E at different locations (A to E) in the journey 202.

As will be described in more detail later, the user may have an intended path from location A to location F, via the intermediate locations B, C, D and E, which may be represented by a path through a plurality of adjacent polygonal areas between location A and location F.

In FIG. 2, the particle set at each location is represented by a number of white dots, each dot representing a respective particle, with the resulting estimated state represented as a black dot. It is assumed that, during the journey 202, there are no external sources of measurement data such as GPS, signals/fields emitted from locator beacons or the like. Further, the particle sets 204 shown represent substantially ‘real time’ determinations.

As seen in FIG. 2, after the device 112 is first carried into the building 114 through doorway 116 by a user to location A, the initial particle set is relatively compact representing a relatively tight probability density. As the device 112 moves to location B, the particles of the particle set begin to spread out, especially along the direction of movement, as uncertainty increases as a result of the accumulation of systematic errors in step length. Systematic errors in the bearing calculation, in this example, result in a deviation from the path of the actual journey 202 through the building.

As the device 112 moves through doorway 212 to location C, the accumulation of systematic errors in the step length and bearing calculations, at location C, has built up resulting in further spreading of the particle set and deviation from the path of the actual journey 202. Moreover, some uncertainty in the route taken is introduced with a number of particles 206 of the particle set 204-C being determined to have taken a path on the wrong side of a wall 213. Whilst, initially, the particles 206 following the incorrect route continue to be tracked, the emphasis placed on them is reduced by reducing their weighting because the mapping data indicates that the path taken by them (being towards a corner of a room) is less likely than the more common pathway through the doorway 212.

In this example, the particles 206 following the incorrect route are initially ‘moved’ from any position calculation that takes them through wall 213 to move alongside the wall while the route they are determined to take remains sufficiently likely but, ultimately, have their weights reduced to zero, or near zero, as they begin to deviate significantly from the route taken by the main cluster of particles and/or when they pass through another wall 214 indicating that the route taken is not merely unlikely, but is in fact impossible (assuming the mapping data is correct). As a result, the particles 206 following the incorrect route are eliminated when the particle set is re-sampled and the device, in effect, learns that the bearing has had a systematic error and, effectively, corrects for it.

Eventually, as the device 112 continues to move to and through doorway 216 towards location D, a number of other particles appear to go through wall 214 (as indicated by the arrows) immediately adjacent (on the south side) of doorway and therefore have their weight updated accordingly (for example to zero) and/or are moved northward towards a more realistic path. Moreover, if the user of the device 112 pauses to open the door this can be determined from the measured motion data from the inertial sensors in combination with an associated stored motion profile for such behaviour. Thus, the device 112 is able to infer that the user of the device is close enough to the door to open it (and possibly close enough to a door release button/security pad or the like) thereby allowing the particles further from that position to have their weights reduced accordingly. On re-sampling, the changes to particle weighting based on inferences made from the mapping data and motion characteristics effectively result in a reduction in the spread of the cluster of particles and hence a refinement to the probability distribution represented by the particle set. This results in an estimated system state having a more accurate position (x, y) and more accurate systematic bearing and step errors (e_{θ}, eₛ) that can be used to provide both: a more accurate real-time position as the user continues the journey 202; and a refinement to improve the accuracy of historic system states.

Thus, the cluster of particles at location D is more tightly packed with a system state estimate that is significantly more accurate than at location C. As the journey continues via locations E and F, the particle set 204 continues to be refined with particles that appear to go through walls (e.g. the circled particles at locations E and F) being reweighted to zero and eliminated during re-sampling thereby allowing further refinement both to the real-time state estimate and to the historic system states.

### Location Tracking Device

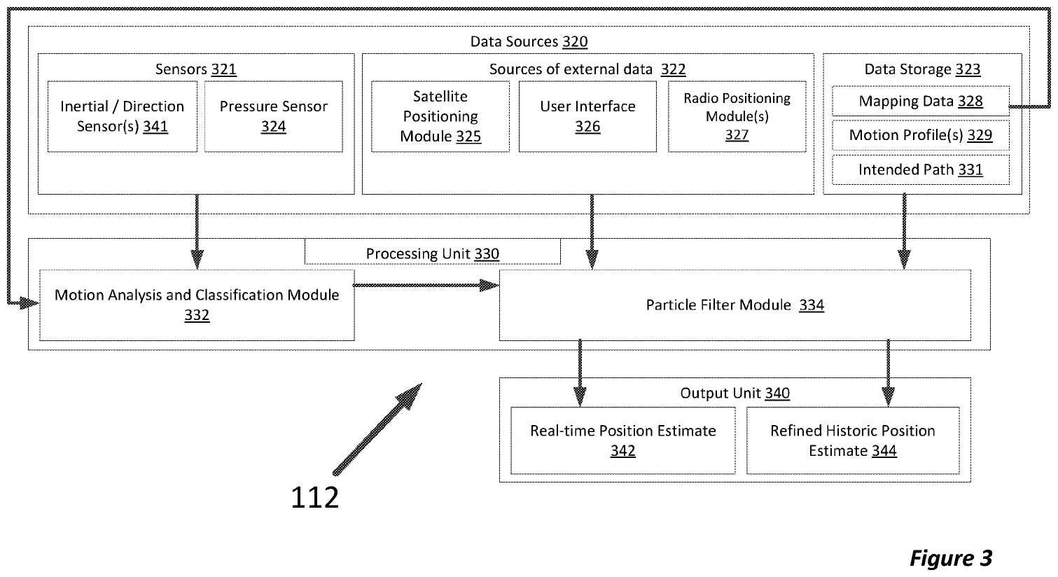

FIG. 3 is a block diagram illustrating a location tracking device 112 for use in the location system of FIG. 1 to track a journey through a building such as that illustrated in FIG. 2.

As shown in the figure, the location tracking device 112 has a number of data sources 320 of movement/position related data, intended path data related to an intended path of the user (and possibly other data such as heading data related to the intended path, as described in more detail later), a processing unit 330 for processing data from the data sources, and an output unit 340 for providing the results of processing by the processing unit 340 for real-time and/or non-real-time access by the user carrying the device 112 or by another user (e.g. an administrative user or managerial user). The location tracking device 112 may correspond to a plurality of physical devices that share a data connection.

The data sources 320 comprise: sensors 321 for sensing movement and providing associated movement/position related data; sources of external data 322 for providing associated movement/position related data based on signals from external sources; and data storage 323 for storing movement/position related data.

The sensors 321 comprise inertial/direction sensors 341 for sensing motion and orientation and for providing associated data from which the device 112 can determine a bearing and can classify user motion appropriately (for example as a walking step, as a pause, as a step up or down a ramp or stair, a running step, or the like). The inertial/direction sensors 341, in this example, comprise a multi-axis (e.g. three orthogonal axis) accelerometer for measuring linear acceleration in different directions, one or more gyroscopes for measuring angular velocity, and a magnetometer based direction sensor (although any suitable inertial sensors may be used).

Where the device 112 is only required to track movement in substantially two-dimensions, the inertial sensors 341 are sufficient to achieve this. Such two-dimensional tracking may, for example, be sufficient in a building where there is little or no level ambiguity (e.g. a single floored building), or in a multi-floored building where movement around each floor is tracked separately in two-dimensions with an external input (e.g. from a user or a beacon) used to confirm which floor the user is on (and hence which floor plan representation to use from the mapping data). However, where the device 112 is required to track movement in three-dimensions the sensors 321 comprise a pressure sensor 324 to provide motion/position related data representing altitude (movement up/down in a ‘z’ direction orthogonal to the x and y directions).

The sources of external data 322, in this example, comprise a satellite positioning module 325 for acquiring global positioning system (GPS) signals (or other similar satellite positioning signals) and for providing associated measurement/position data. The sources of external data 322 also comprise a user input module 325 for acquiring user input relating to the device's position (and other user input) and for providing associated measurement/position data. The user input relating to the device's position may be a simple indicator (e.g. on the press of a button) that the user has entered or left a building, or may comprise an identifier of a general location (e.g. building, floor, room, doorway, or the like) that the user has entered or is about to enter. The sources of external data 322 may also include modules for obtaining any other suitable forms of external data such as image recognition data, lidar data or audio data.

The sources of external data 322 may also comprise one or more radio positioning modules 327 adapted to detect associated radio signals from sources having a known position, to measure the strength, or other characteristic, of any detected signals and to provide associated measurement/position data to improve refinement of the particle set. For example, a cellular radio positioning module may be provided for detecting and measuring the strength of radio signals from a cellular base station (macro, pico, femto or otherwise), for identifying the originating base station, and for estimating a position relative to that base station. The one or more radio positioning modules 327 may also be adapted to detect associated radio signals from another user device, to determine a proximity to the other user device.

A beacon based radio positioning module may alternatively or additionally be provided for detecting signals from dedicated positioning beacons provided within the building, for identifying the originating beacon, and for providing the information identifying the beacon as measurement/position data for use in refining the estimated position of the device 112. Once identified, the identified beacon's location may be determined (e.g. by reference to a look-up table mapping beacon identity to a specific location) and this information may be used either by itself, or together with a signal strength based estimate of distance from the identified beacon (also provided by the radio positioning module), to refine the positioning. For example, a respective beacon having a unique identity may be provided at the exit of an elevator on each floor of a multi-floored building. Thus, once the beacon is identified, the device 112 is able to determine onto which floor (and from which elevator) of a building the device 112 has entered. This would allow two-dimensional tracking to continue based on mapping data representing a floor-plan of the identified floor but could also be used to refine a particle set for three-dimensional tracking by helping to reduce errors in altitude associated with pressure measurements.

Other possible radio positioning modules include WiFi, Bluetooth, Near Field Communication (NFC) based radio positioning modules or the like. Other positioning modules having a similar function may employ other parts of the electro-magnetic spectrum and may include, for example, modules for positioning using visible and/or infra-red parts of the spectrum.

The data storage 323 comprises mapping data 328 representing a map of each floor of the building (or other location) that the device 112 is being used in. This mapping data may be pre-loaded onto the device 112 and/or may be loaded onto the device, or updated, using an appropriate wired or wireless communication technology. The data storage 323 also includes other information for assisting location tracking including, for example, one or more motion profiles 329 each representing a particular user movement characteristic such as a walking step, a pause, a step up/down a ramp or stair, a running step, upward/downward movement in an elevator and/or the like.

The data storage 323 also includes intended path information 331 corresponding to an intended path of the user. For example, referring back to FIG. 2, the intended path information 331 may be an intended route of the user through the building from location A to location F. As described in more detail later, the mapping data 328 may include a plurality of logical areas (e.g., tessellating polygonal areas), and the intended path information 331 may (but need not necessarily) correspond to a contiguous set of the areas.

The data storage 323 may also comprise other data for assisting positioning and/or motion classification such as, for example: look-up data for mapping beacon identities to specific geographic locations represented by the mapping data; data representing a radio signal characteristics map for comparison with corresponding measured radio signal characteristics to determine a device position relative to the radio signal characteristics map and hence in the building; and any other such data.

The processing unit 330 comprises a motion analysis and classification module 332 and a particle filter module 334.

The motion analysis and classification module 332 performs data fusion and analysis procedures on the raw data from the sensors 321 to help reduce errors and thereby provide improved motion data. The motion analysis and classification module 332 classifies the motion represented by the improved motion data based on the motion profile(s) stored in the data storage 323 and reports a bearing estimate and step length (and possibly a step height for movement up or down stairs) to the particle filter module 334 each time a step is detected. The motion analysis and classification module 332 may also report detection of other events to the particle filter module 334 such as, for example, detected movement in an elevator (with or without an associated altitude change estimate), an apparent pause in movement, or the like.

The particle filter module 334 produces and weights the particle set 204, predicts the movement of individual particles, as the device 112 moves through a building or other such location, based on the data from the motion analysis and classification module 332. The particle filter module 334 uses Bayesian statistics to update the weighting of each particle in the particle set 204 based on data from other disparate data sources such as the satellite positioning module 325, the user interface 326, other radio positioning module(s) 327, the stored mapping data 328, the intended path data 331 or other stored data. The re-weighted particle set 204 is resampled by the particle filter module 334 to produce a new set of equally weighted particles representing a refined probability density for the system state (position and errors) of the device 112. The particle filter module 334 generates, from the re-weighted and resampled particle set 204, a real-time estimate of the system state and hence position. The particle filter module 334 also uses the re-weighted and resampled particle set 204 to update particle sets, and hence estimates, for previously determined historic system states and hence position.

The output unit 340 provides the means by which the device 112 can output, to a user, the real-time position estimate 342, the historic position estimate 344 and any other real-time or previously stored data (such as real-time and/or historic particle sets, motion profiles, radio characteristics maps etc.). The output unit 340 can output the information via any suitable output device or interface (e.g. audio, visual, wired or wireless data interface, or the like) either automatically (e.g. real-time on a display) or at the request of the user via the user interface 326.

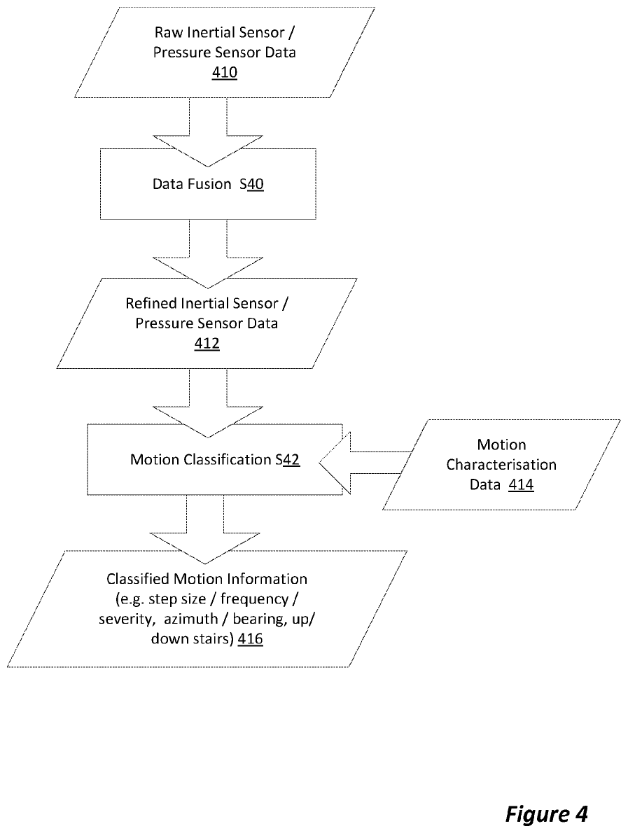

Methods of motion classification, updating position estimates and updating the particle set based on motion information without using the intended path information will now be described with reference to FIGS. 4 to 6. An improved method using the intended path information to generate more accurate and relative real-time position estimates will be described in more detail later.

### Motion Classification

FIG. 4 is a simplified flow chart illustrating operation of the apparatus of FIG. 2 to classify motion.

As seen in FIG. 4, data fusion is performed on the raw inertial and any pressure sensor data 410 at S40 to refine that data. Specifically, a Kalman filter (or extended Kalman filter or other similar method) is used in a ‘pre-processing’ step, to correct errors in the measurement data from the inertial/direction sensors 341 (gyroscope/accelerometer/magnetometer) and any pressure sensor 324, such as errors associated with stray magnetic fields registered by the magnetometer, acceleration errors, and/or errors associated with pressure fluctuations registered by any pressure sensor 324. This pre-processing improves accuracy and provides an optimal blend of gyroscopic, magnetometer and/or other data which, in effect, makes the magnetometers self calibrating. For reasons of clarity and succinctness, the (extended) Kalman filter is not described here in detail but is well documented in scientific and public literature and will be well known to those skilled in the art. The data fusion process uses the corrected data to produce refined data 412 representing quantities of interest such as device orientation, acceleration in directions of interest, and refined pressure differentials.

The refined data 412 is used, at S42, in combination with motion characterisation data 414 (e.g. motion profiles) to classify the motion and produce classified motion information 416 which may, for example, include information identifying the nature of steps being taken by a user (e.g. estimated step length, step frequency and severity), the user direction of heading (azimuth bearing), and whether the user is going up or down stairs.

### Updating Position Estimates

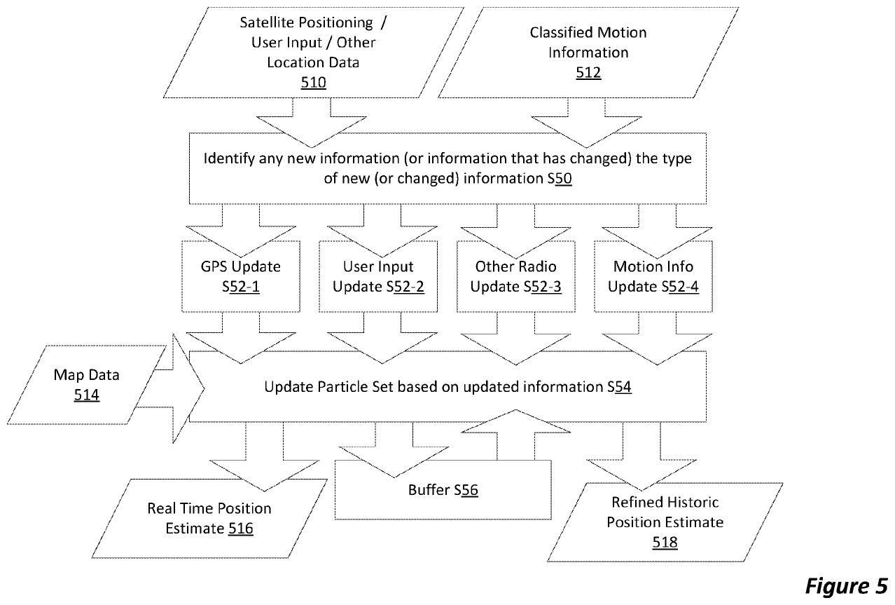

FIG. 5 is a simplified flow chart illustrating operation of the apparatus of FIG. 2 to provide updated position estimates in more detail. In FIG. 5 it is assumed that the device 112 has already commenced a journey and one or more previous position estimates have been made.

As seen in FIG. 5, any available data 510 from the external data sources 322 (e.g. satellite positioning data/user input data/or positioning data based on other radio or non-radio sources, such as image recognition data, lidar data or audio data) is used in conjunction with classified motion information 512 from the motion analysis and classification module 332 is processed at S50 to determine if there is any new information (or information that has changed) and the type of any new (or changed) information.

Any new or changed information found at S50 that is required by the particle filter module 334 is then extracted, to provide appropriate updated information, using one of a plurality of different information type dependent update procedures (S52-1 to S52-4).

The particle filter module 334 is then used, at S54, to update the weightings of the current particle set based on the updated information and any relevant mapping data 514, to resample the particle set, and then to extract a real-time position estimate 516. The position estimate may be extracted by calculating a weighted average of the set of candidate locations. The weighted average may be, for example, an arithmetic mean, geometric mean or a harmonic mean. The current and/or updated particle set can alternatively or additionally be buffered, at S56, for refinement (or further refinement) in the future based on subsequent information updates to provide a delayed but refined historic position estimate 518.

### Updating Particle Set Based on Motion Information

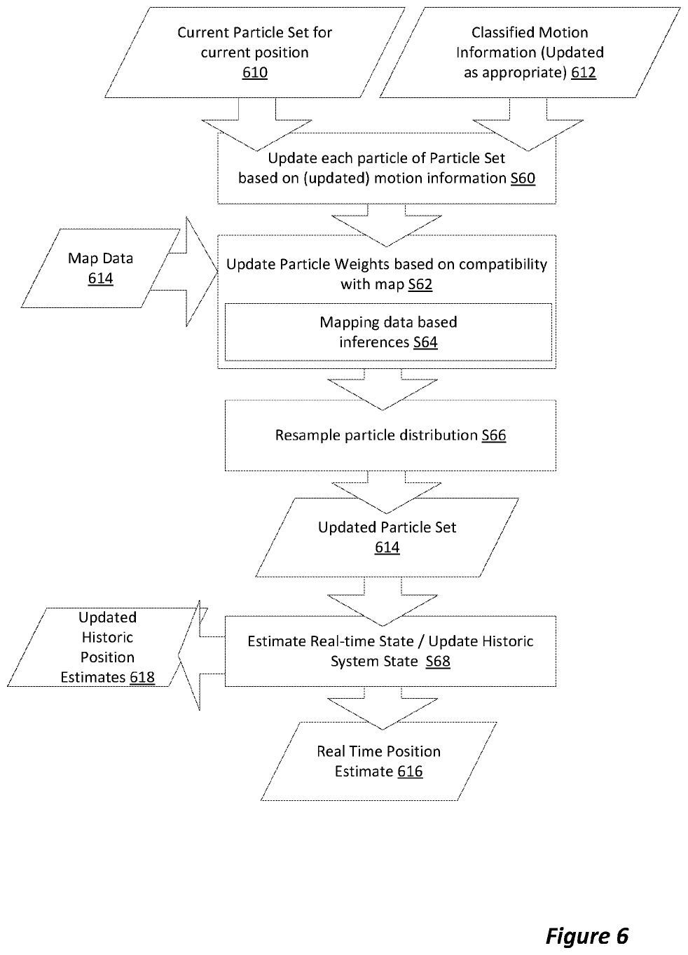

FIG. 6 is a simplified flow chart illustrating, in more detail, operation of the apparatus of FIG. 2, during part of the process of FIG. 5 to update a particle set and perform a position estimate. In this example, the update is based on updated motion information and mapping data without other external sources of measurement such as GPS or the like.

As seen in FIG. 6, classified motion information 612 from the motion analysis and classification module 332 is used, in conjunction with a current particle set 610, at S60, effectively to ‘move’ each particle in accordance with the estimated movement (estimated distance and estimated direction) indicated by the classified motion information 612. Specifically, the state represented by each particle is modified in accordance with a so called ‘forward model’. The forward model essentially moves a particle, for each step made by a user carrying the device 112, forward a distance represented by the estimated step length ‘s’ when corrected (when the error parameters are used) by an amount equal to the systematic step length error ‘eₛ’ (i.e. distance=s−eₛ). Similarly, the direction moved by the particle, in accordance with the forward model, is the estimated bearing ‘θ’ when corrected (when the error parameters are used) by an amount equal to the systematic bearing error ‘e_{θ}’ (i.e. direction=θ−e_{θ}). Formally, the model may be written as:

$$[ \begin{matrix}x \\ y \\ {e}_{θ} \\ {e}_{s}\end{matrix} ] = [ \begin{matrix}x + ( s - {e}_{s} ) cos ( θ - {e}_{θ} ) \\ y + ( s - {e}_{s} ) sin ( θ - {e}_{θ} ) \\ {e}_{θ} \\ {e}_{s}\end{matrix} ] + v$$

Where, v is random noise to account for unmodelled deviations from the deterministic part of the forward model. The random noise is assumed to be zero-mean multivariate and normally distributed.

Once the particles of the particle set have been ‘moved’ in accordance with the forward model, the particles are re-weighted at S62. This step includes re-weighting based on inferences made from any relevant mapping data at S64 and re-weighting based on any other available information (for example, based on an intended path or heading, as will be described in more detail later). The re-weighting based on inferences made from any relevant mapping data at S64 includes re-weighting based on mapping data representing walls using a wall handling algorithm. Specifically, particles that move through a building wall in the process of their forward step are assigned zero (or near zero) weight.

Each wall is expressed, in the mapping data, generally using a start point/stop point pair and an infinite line of the conventional straight line form a+bx+cy=0 although non-straight walls (or other obstacles) can be represented using an appropriate equation or list of co-ordinates.

The procedure for determining which particles have crossed a wall minimises computation by only making full particle/wall comparisons where necessary. The procedure (in the case of straight walls) is as follows:
(a) Identify and remove all walls which are sufficiently far from the set of particles.
(b) Identify which particles cross the infinite version of each wall by determining whether the value of a+bx+cy for a particle's (x, y) position before the movement has a different sign (negative or positive) to the value of a+bx+cy for a particle's (x, y) position after the movement. If the sign changes during the course of a movement the infinite version of the wall has been crossed.
(c) For particles which are found to cross the infinite version of a wall, check whether the wall crossing is legitimate or not (i.e. does the particle pass through a known doorway, opening, or beyond the end of the wall). This is achieved by checking if the crossing occurs between the start point and stop point of that wall. If the particle does cross the wall between the start point and stop point of that wall this does not represent a legitimate crossing and so the particle is reweighted.

It will be appreciated that the mapping data can be used for to make other inferences than whether the particle exhibits movement through a wall. A further example of how the map could be used to update particle weights is to apply larger weights to “indoor” particles than to “outdoor” particles if no satellite tracking (e.g. GPS) signals are received for a long time period thereby indicating that the device 112 is indoors and that outdoor particles are less likely to represent a genuine position.

Once the particle set is re-weighted it is resampled at S66 to remove lower weight particles and spawn further particles from higher weight particles. This ensures that computational effort is focussed more efficiently by concentrating on propagating particles in relevant areas of the state space.

Resampling is carried out every time step as follows:
(a) Let N be the (constant) number of particles.
(b) Make N independent selections from the set of particles where, for each selection, the probability of choosing a particular particle i is proportional to the weight of the particle i. Thus, higher weight particles are more likely to be selected more than once and lower weight particles may not be selected at all. Zero weight particles will not be selected and will, therefore, no longer be propagated.
(c) Add random “jitter” to each of the selected particles—the “jittered” selected particles are the new particle set.
(d) All particles are assigned equal weight (i.e. 1/N).

Jitter is applied in step (c) because the process of resampling can result in multiple copies of a single (higher-weight) particle. This can have the side-effect of reducing the diversity in the particle set. The particle diversity can be increased by adding a small amount of random noise to each particle during resampling. This process is referred to as “jittering” and ensures that there continues to be a particle set with a diversity of states able to cover more of the possible user states.

Thus, the addition of random jitter improves performance as it increases the sample diversity of the particles. In this example, the ee and eₛ components are each jittered by a zero mean, normally distributed component. The location components of the state vector are not jittered to avoid having to perform wall-handling again.

After resampling, the real-time system state is estimated and the historic system states updated at S68 to provide a real-time position estimate 616 and an updated historic position estimate 618. The standard method for obtaining a state estimate is to calculate the mean over the set of particles. Covariance can also be calculated directly from the particle set. It will be appreciated, however, that more sophisticated state summaries which take into account the possibility of multi-modal distributions may also be inferred from the particle set.

### Updating Particle Set Based on Location Information

The particle filter module 334 will sometimes receive satellite location estimates, denoted (X_{GPS}, Y_{GPS}) along with associated uncertainty level, σ_{CPS}. In this situation, the weights for the set of particles are adjusted proportionally to how well they fit with the satellite location measurement.

In more detail, where d denotes the vector between the satellite location estimate and a single particle's location estimate, and the particle's weights before and after re-weighting are respectively denoted by w_{b} and wₐ, the equation for the updated weight of the particle is given by:

$${w}_{a} = {w}_{b} \cdot {e}^{- \frac{1}{2} ( {d}^{T} [ \begin{matrix}{σ}_{GPS}^{2} & 0 \\ 0 & {σ}_{GPS}^{2}\end{matrix} ] d )}$$

After all particle are re-weighted, they are rescaled so that the sum of the weight is unity.

This weighting corresponds to the assumption that satellite positioning errors are normally distributed with zero mean and standard deviation σ_{GPS}. From the viewpoint of Bayesian statistics, the above weighting corresponds to scaling the particle weighting by the likelihood function for a satellite measurement under the above assumptions.

It can be seen, therefore, that the apparatus described above is configured for carrying out a method involving generating a particle set comprising a plurality of particles each particle representing a respective estimate of a candidate state of the object, wherein the estimated candidate state comprises an estimated position of the object and may also comprise at least one estimated error associated with movement of said object. The apparatus is further configured for carrying out a method involving detecting and analysing movement of the object: to estimate distance travelled by the object; and to determine an estimated direction of movement of the object, and adapting the particle set to reflect an estimated change in position represented by the estimated distance travelled by the object, and the estimated direction of movement of the object. It can be seen that this provides benefits in terms of improved location tracking. Depending on which of the beneficial features described above are implemented the improvements may include, inter alia, improved accuracy of position estimates, greater flexibility to use the apparatus in a wide range of different situations and/or by different users, and faster real-time tracking of position.

### Intended Path Information

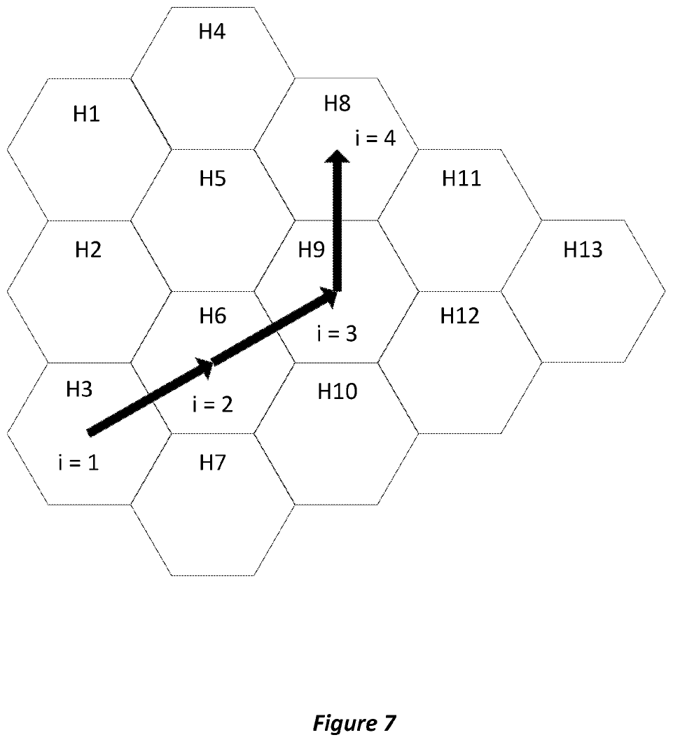

A further improved method of estimating a position of the user, using information related to an intended path of the user, will now be described with reference to FIGS. 7 to 13.

In a pedestrian navigation application, the user is likely to have an intended path that the user wishes to follow. For example, the user may wish to follow a route through a building (such as that illustrated in FIG. 2) from an entrance to a particular location (for example, from location A to location F of FIG. 2). Data related to the intended path of the user can be stored as the intended path information 331 in the data storage 323 and used to generate more accurate and reliable real-time position estimates.

An intended path (i.e. an intended or expected route) of the user may be obtained, for example, by the user directly inputting the intended path into the device 112 via the user interface 326 for storage in the data storage 323. The intended path may also be referred to as an ‘expected path’, since it is a path that the user is expected to take between two locations (for example, a route between a starting location or current location of the device and an intended destination, rather than the expected short range motion of the device). The intended path may be inferred from an intended destination of the user. For example, the user may input an intended destination into navigation software, and the intended path of the user may be determined to be the shortest route (either in time or distance) between the user's current location and the user's intended destination, or the most commonly used route (based on historical data from the user device or a wider set of devices) between the user's current location and the user's intended destination. The determination of the intended path may take into account any suitable form of ‘cost’ associated with a potential route. For example, a route associated with a large number of steps (e.g. a route that includes staircase) may be assigned a high cost for users who are travelling in a wheelchair, and therefore that route is less likely to be determined as the intended path. Areas that are unlikely to be used for navigation may be assigned a high cost (for example, a section of a river, or a restricted area such as an airfield), and are therefore less likely to form part of the determined intended path. Any other suitable method of obtaining the intended path of the user may be used (for example, by downloading the intended path via the internet, for storage in the data storage 323).

The determination of the intended path may take into account the areas most frequently travelled through by other users, to increase the probability that these areas will be determined to form part of the expected path. The determination of the intended path may take into account the areas most frequently travelled through by other users when the other users are travelling to destinations that are within a predetermined threshold distance of the intended destination of the user, to increase the probability that these areas will be determined to form part of the expected path.

FIG. 7 shows an arrangement of polygonal areas (in this example, hexagons) labelled using a set of identifiers H1 to H13. The polygonal areas may be referred to as ‘logical areas’ that each correspond to a ‘real’ area of space. The set of hexagons H1 to H13 may be stored as mapping data 328 in the data storage 323. The solid arrows indicate an intended path of the user, starting from hexagon H3 and ending at hexagon H8, via intermediate hexagons H6 and H9. It will be appreciated, therefore, that hexagons H3, H6, H9 and H8 represent an intended path of the user. Each hexagon along the intended path is sequentially labelled with an index i, such that the value of i increases by 1 for each hexagon along the expected path. In other words, the user intends to start at the hexagon having i=1, to then move to the hexagon having i=2, to then move to the hexagon having i=3, and so on. The intended path 331 of the user is stored in the data storage 323, for example as the sequence of identifiers H3, H6, H9 and H8. It will be appreciated, therefore, that the value of the index i corresponding to the hexagonal area in which the user is currently located (or estimated to be located) can be used to determine the next hexagonal area to which the user is expected to move.

It will be appreciated that the shapes used to divide the physical location into discrete logical areas and to model the expected path need not necessarily be hexagonal, and that any other suitable shape or set of shapes may be used. For example, a set of tessellating rectangles, a set of polygons or irregular shapes may be used. The logical areas need not all have the same size or shape, and may be overlapping or non-overlapping.

For navigation in buildings having multiple floors (or other vertically overlapping regions, such as a bridge over a road) each polygon may also be associated with a floor number or other indication of elevation. An index corresponding to a floor number may be stored in association with each hexagon identifier as mapping data 328 in the data storage 323. For example, a region corresponding to a flight of stairs may be represented by a set of vertically stacked (or partially overlapping) polygonal areas, each having a corresponding floor or elevation identifier. For each floor of a building, the polygons representing that floor have a unique identifier (in this example, the identifiers H1 to H13), so that each polygonal area can be uniquely identified on that floor.

Whilst in this example the intended path of the user from hexagon H3 to hexagon H8 corresponds to a sequence of contiguous areas (hexagons H3, H6, H9 and H8), this need not necessarily be the case. Moreover, the set of polygons used to represent the intended path may overlap. For example, loops in the intended path may be represented by polygons later in the sequence overlapping polygons that are earlier in the sequence. Alternatively, a single polygon may be assigned a plurality of values of the index i, indicating that the user is expected to enter that polygon a plurality of times as the user progresses along the intended path.

Referring back to FIG. 1, when the intended path of the user is used to provide more accurate estimates of the location of the user, the state space includes additional information. The state space information may include whether a particle lies on the intended path (i.e. whether the particle lies within an area that forms part of the intended path). If the particle is not on the intended path, the state space information may indicate whether the particle has previously been on the intended path. If the particle is on the intended path, the state space information may indicate the corresponding polygonal area (for example, one of the identifiers H3, H6, H9 or H8 of FIG. 7, or the corresponding index i). As described in more detail below, if a particle was on the intended path but has now departed the intended path, the state space information may indicate the furthest polygon reached along the intended path before it left the intended path using a corresponding negative value of i.

State Initialization with Intended Path

When particles are created, the state space is initialized with suitable parameter values. The state space includes a parameter for indicating the location of a particle relative to the intended path. This parameter can either be initialized as 0 (indicating that the particle does not lie on the intended path), or initialized as a positive value of the integer i (indicating that the particle is located along the intended path). The ‘parameter for indicating the location of a particle relative to the intended path’ may also be referred to as the ‘stored value of i’ or the ‘path state’ of each particle.

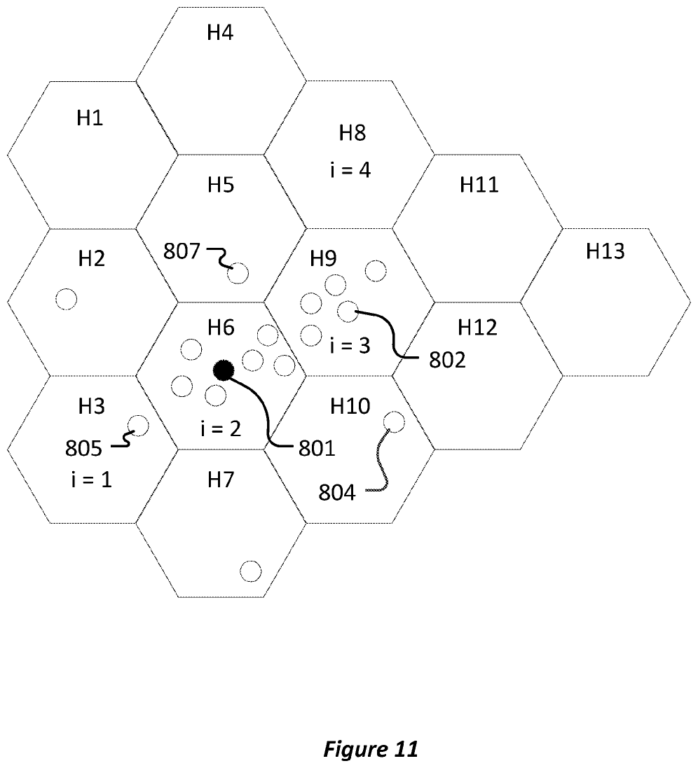

If the user is initially at a known location on the intended path (based on, for example, a recent GPS measurement), then the particles are initialized with the positive integer i corresponding to that polygon of the intended path. For example, referring now to FIG. 11, when the solid black particle 801 is initialized inside hexagon H6 a value of i=2 is stored, indicating that the particle lies on the intended path (within the area defined by hexagon H6).

If the initial location is unknown, or there is a large amount of uncertainty in the initial position, then the particles can be initialized using a number of different methods. For example, the particles could be distributed around a previous GPS or Bluetooth Beacon position measurement, or could be distributed along the intended path in any other suitable manner.

The state of each particle can be initialized using the following set of constraints:
If the particle is at position X and X is not within polygon K, then the particle state must not be that the particle is within polygon K.
If the particle is not within any polygon, then the polygon state must not be that the particle is on the intended path.
If the particle state is that the particle has left the intended path, and that the most recent polygon that the particle was in was polygon J, then the particle position must not be within the polygon immediately following J on the intended path, nor any of the subsequent polygons that the particle is allowed to move to in the Forward Step part of updating the state space (described in more detail later).

### Forward Step

When the intended path information is used, the above described method of updating the particle state information is modified to also update the integer i that represents the progress along the intended path. The stored value of integer i for each particle is updated when the corresponding particle joins the intended path for the first time, moves from one polygon to another along the intended path, departs from the intended path, or rejoins the intended path.

The particle filter checks all polygons, after the particles have moved, to determine whether any particles have entered a polygon on the intended path for the first time. In other words, the particle filter checks if there are particles having a stored value of i=0 that are now located within a polygon along the intended path. If yes, then the corresponding particles are labelled using the index (integer i) of the corresponding polygon. For example, referring to FIG. 7, when a particle enters hexagon H3 and has not previously been on the intended path, a value of i=1 is stored in association with that particle.

When a particle moves from one polygon to another, and both of those polygons form part of the intended path, the particle filter checks if the particle has moved to a polygon on the intended path within an acceptable range of indices. For example, for a particle to be deemed to still be on the intended path, the particle may be required to only go to the next polygon along the intended path, or to a polygon within a predetermined number of steps along the intended path.

A particle may, for example, be deemed to have deviated from the intended path when:
The particle does not lie within the area of any polygon corresponding to the intended path (in the example of FIG. 7, the particle does not lie within any of the areas defined by hexagons H3, H6, H9 or H8)
The particle moves backwards along the intended path (for example, from a polygon having i=4 to a polygon having i=3).
The particle lies within a polygon along the intended path, but outside an allowed index range.

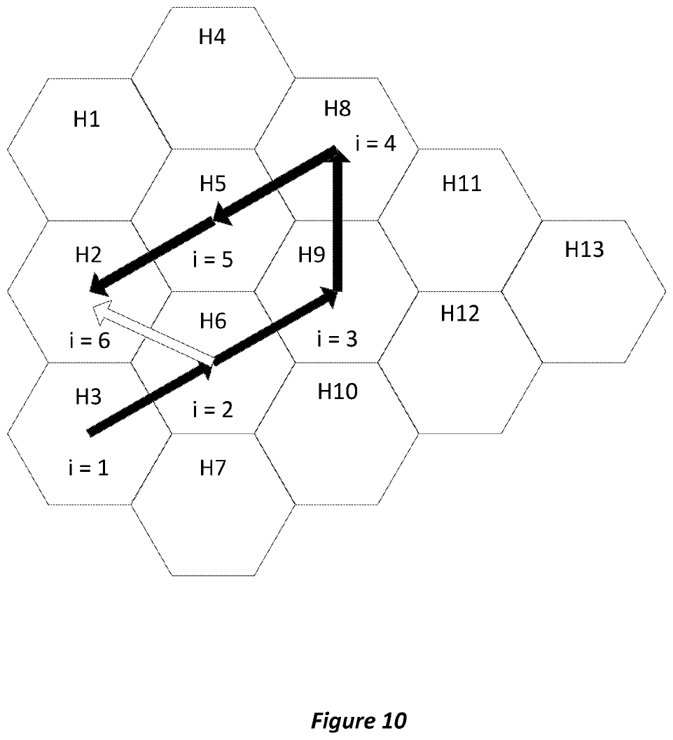

An example in which a particle moves from a polygon along the intended path to another polygon along the intended path, but is nevertheless deemed to have left the intended path, is illustrated in FIG. 10. The solid black arrows in FIG. 10 represent an intended path of the user from hexagon H3 to hexagon H2 via intermediate hexagons H6, H9, H8 and H5. The solid white arrow indicates a particle that has moved from hexagon H6 to hexagon H2. In this example, the allowed index range (i.e. the allowed change in i) for a particle to be deemed to be on the intended path is from 0 to 2. In the example of FIG. 10, the particle has moved from hexagon H6 having i=2 to hexagon H2 having i=6. Therefore, the movement of the particle to hexagon H2 corresponds to an increase of i by 4. Therefore, the increase in i does not lie within the allowed index range, and the particle is deemed to have left the intended path. Since the particle has deviated from the intended path, a value of i=−2 is stored in association with that particle, to indicate the location at which the particle deviated from the intended path (in other words, the stored value of i=2 previously obtained by entering, or being initialized inside, hexagon H6 is made negative for that particle). In contrast, if a particle had moved from hexagon H9 (having i=3) to hexagon H5 (having i=5) the increase in i would be 2, which is within the allowed index range. Therefore, a particle moving from hexagon H9 to hexagon H5 would be determined to be on the intended path, even though it has not passed through the intermediate hexagon H8.

### Deweighting and Reweighting

As described in detail above, each of the particles used in the particle filter method has a corresponding weight. A method of updating the particle weights using the intended path information will now be described.

Each hexagonal area may have a corresponding deweighting factor α stored in association with the hexagonal area in the data storage 323 (for example, referring to FIG. 7, a value of α=0.7 may be stored in association with the hexagon identifier H6, or in association with the corresponding value of i). The value of a is used to decrease the weight of a particle that deviates from the intended path. In this example, the value of a is between (and including) 0 and 1, and is multiplied with the weight of a particle that deviates from the intended path to generate an updated (reduced) weight. This processes is referred to as ‘deweighting’. Beneficially, since a value of a is stored in association with each of the polygonal areas, the value of a can be used to locally control how much the weight of a particle that deviates from the intended path should be decreased. For example, when there is only one likely route along the intended path in a particular region, the value of a can be set close to zero in that region, such that any particle that deviates from the intended path in that region will be given a low weight after the weight update step. For example, when a portion of the intended path corresponds to walking over the middle of a bridge, it is unlikely that the user will depart from the set of polygons that represent the area of the bridge, and therefore those polygons may be assigned a low value of a. In contrast, in regions where it is more likely that the user will depart from the intended path (for example, when the path passes through a large atrium or other region of open space), the polygons representing that region can be assigned a relatively large value of a. In other words, by storing a value of a in association with each of the polygonal areas, the strength of the influence of departures from the intended path on the particle weights can be varied along the length of the intended path. A global parameter may also be stored in the data storage 323 for adjusting the overall deweighting effect of departing from the intended path at all points along the intended path.

If the value of a is set as 0, (and a is used to multiply the weight, rather than divide, as described later), then the resulting particle weight will be 0 and the particle will be removed in the next resampling step. If the value of a is set as 1 then there is no deweighting effect (unless a global deweighting factor is also used).

The values of a for each polygonal area may be set manually (for example, by a system administrator), or may be determined based on historical data. For example, historical data may indicate that users are very unlikely to deviate from the intended path in certain areas, and the values of a corresponding to those areas may be set to apply a strong deweighting effect.

The deweighting factor is applied to a particle each time that particle leaves the intended path. Since the weights are stored in association with each particle, the deweighting factor penalizes particles that were once on the intended path but deviated from the intended path, regardless of how long the particle has been off the intended path.

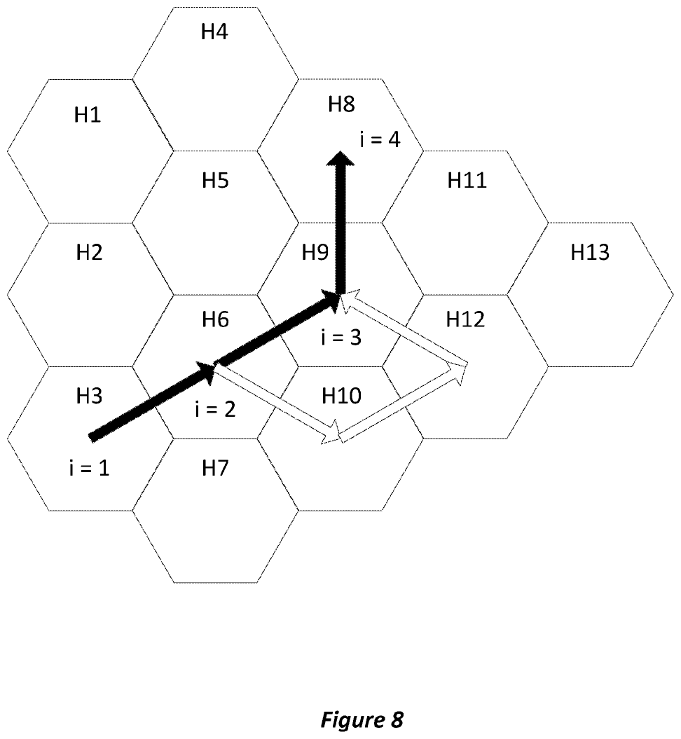

FIG. 8 shows a modified version of FIG. 7 in which a deviation from the intended path by a particle is indicated by the solid white arrows. The solid white arrows represent a particle that moves from hexagon H6 to hexagon H9 via intermediate hexagons H10 and H12. After the particle moves from hexagon H6 to hexagon H10 the deweighting is applied—the value of a stored in association with hexagon H6 is multiplied with the particle weight to reduce the value of the particle weight. Alternatively, the values of a stored in association with each polygonal area, and/or the global deweighting parameter, may be greater than 1, in which case the deweighting can be implemented by dividing the weight of particles that deviate from the expected path by the corresponding value of a and/or the global deweighting parameter.

In the example of FIG. 8, and particle starting in hexagon H3 will initially have a stored value of i=1. When the particle moves to hexagon H6, the stored value is updated to i=2. Advantageously, when the particle deviates from the intended path by moving to hexagon H10, the stored value of i is made negative. In this example, the stored value is updated to i=−2. Therefore, the stored value can be used to determine the location at which the particle first deviated from the intended path. Alternatively, any other suitable identifier may be stored in association with the particle that left the indented path, for identifying the location at which the particle first deviated from the intended path.

If a particle leaves the intended path and then revisits a polygon that is earlier on the intended path (for example, if the particle moves from hexagon H6 (i=2) to hexagon H7, and then to hexagon H3 (i=1)), then that particle is still deemed to have left the path and keeps the state information associated with the polygon later on the path. In this example, of value of i=−2 is maintained in the state information even if the particle returns to the intended path at hexagon H3. In this way, the information representing the furthest polygon reached along the intended path before the particle left the intended path is maintained in the state information.

In the example of FIG. 8, the particle moves from hexagon H10 to hexagon H12, and then from hexagon H12 to hexagon H9. Hexagon H9 (having i=3) lies on the intended path. The magnitude of the stored value of i=−2 associated with the particle before moving to hexagon H9 is compared to the value of i=3 associated with hexagon H9. Since the value of i=3 associated with hexagon H9 is greater than the magnitude of the stored value of i=−2 associated with the particle (and the difference between these values lies within an allowable range, as described above), it is determined that the particle has rejoined the path at a position that is further along the expected path (hexagon H9) than the point at which the particle departed from the expected path (hexagon H6). Therefore, the value of i associated with that particle is updated to i=3, and the particle is deemed to have rejoined the expected path.

In other words, if a particle which has left the intended path enters a polygon on the intended path, and the polygon is further along the intended path than the polygon from which the particle has left the intended path (optionally within an allowable range), then the particle is determined to have rejoined the intended path.

When a particle rejoins the expected path, a reweighting factor (or ‘upweighting’ factor) can be applied to increase the weight associated with that particle. The size of the reweighting factor can be the same as the deweighting factor applied to the particle when it left the intended path, to effectively cancel out the deweighting effect when the particle rejoins the intended path. Alternatively, the reweighting factor can be smaller than the deweighting factor applied to the particle when it left the intended path, so that there is a permanent deweighting effect each time the particle deviates from the intended path, even if the particle rejoins the intended path. The reweighting factor may also be applied when a particle joins the intended path for the first time.

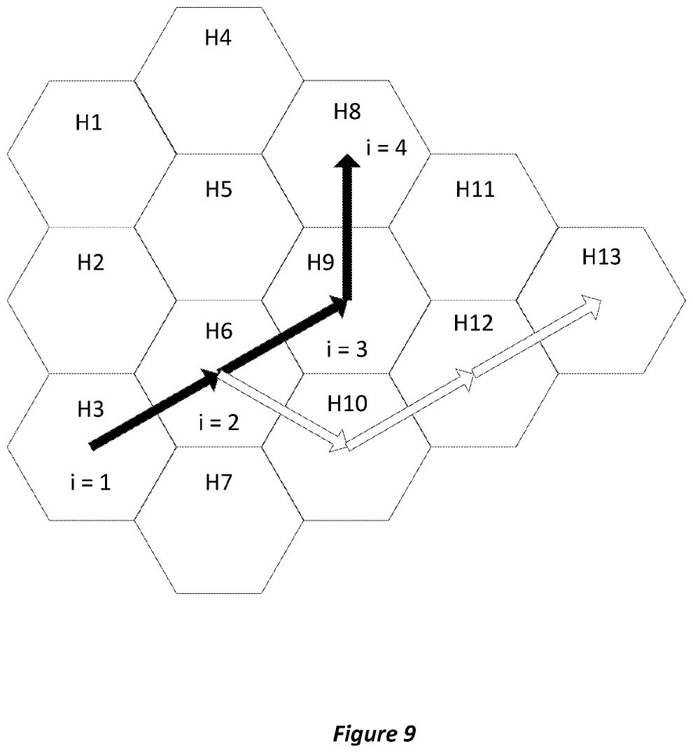

FIG. 9 shows a simplified schematic illustration of a particle that deviates from the intended path, but does not rejoin the intended path. As illustrated in the figure, the particle moves from hexagon H6 to hexagon H13, via intermediate hexagons H10 and H12. As the particle moves from hexagon H6 to hexagon H10 the deweighting factor is applied (using the value of a associated with hexagon H6, and optionally also applying a global deweighting factor). The value of i associated with the particle is updated to i=−2, to indicated that the particle left the intended path at the hexagon having i=2. Since the particle does not rejoin the intended path, no reweighting factor is applied and the particle is therefore more likely to be removed in the next resampling step.

It will be appreciated that when a particle leaves the intended path either the value of a stored in association with the area on the path, or the value of a stored in association with the area to which the particle moves could be used to apply the deweighting. For example, referring to FIG. 9, when the particle moves from hexagon H6 to hexagon H10, either a value of a stored in association with hexagon H6 or a value of a stored in association with hexagon H10 could be used to apply the deweighting (optionally in combination with a global deweighting parameter). Alternatively, a global deweighting parameter could be used without using local deweighting parameters. Similarly, referring to FIG. 8, when a particle rejoins the intended path by moving from hexagon H12 to hexagon H9, a reweighting parameter associated with hexagon H9, a reweighting parameter associated with hexagon H12, and/or a global reweighting parameter could be used to apply the reweighting.

Additional deweighting or reweighting factors that are not necessarily associated with the intended path may also be stored in association with some or all of the hexagons. For example, hexagons that correspond to an area that is associated with high footfall may have an additional reweighting factor, since it is more likely that a user will use that area as part of their route. In other words, additional deweighting or reweighting factors may be stored in association with the hexagons based on whether an area is generally more likely or less likely to from part of a route travelled by a user.

### Additional Deweighting

The method for obtaining outputs from the particle filter includes calculating a weighted sum of the values obtained from the particle states. For example, position estimates can be derived as a weighted sum of the particle positions, weighted according to the current state of the particles.

When the intended particle information is used, an additional penalty term (additional deweighting factor) can be applied to particles that are not located along the intended path. After applying this penalty, the weights are renormalized so that the total weight of all particles is unchanged. After renormalization, the weights can be used for output calculations according to the above described methods. A variable additional deweighting parameter may be used to control the strength of this additional deweighting for particles that are not located along the intended path.

### Resampling

As part of the resampling step, new particles may be sampled from the existing particle set. If a particle is created in this way, the augmented state vector is copied from the original particle. However, as described above, in some cases it may be useful to make modifications to the state vector such as the addition of random jitter in state variables such as the location or heading. In particular, if the position jitter is used and the addition of jitter means that the particle has entered or left a polygon on the intended path, the intended path state is updated as necessary to ensure the state is consistent (the consistency requirements are the same as those at particle initialization, described above).

### Example Particle Distribution Within Polygonal Areas

FIG. 11 shows an exemplary distribution of particles within the set of polygonal areas H1 to H13. The intended path from hexagon H3 to hexagon H8 corresponds to that indicated by the solid black arrows in FIG. 7. The solid black particle 801 represents a previous position estimate that is located along the intended path (since hexagon H6, having i=2, lies along the intended path).

As illustrated in the Figure, particle 802 is located in hexagon H9 having i=3. Since the value of i has increased by 1 compared to the location of the previous position estimate 801, the particle 802 is deemed to be on the intended path. The updated value of i=3 is stored in association with particle 802.

Particles 804 and 807 are not located in a hexagon that forms part of the intended path. Therefore, since hexagon H6 (having i=2) was the point at which these particles left the intended path, the value i=−2 is stored in association with particles 804 and 807.

Particle 805 has moved backwards along the intended path, from hexagon H6 (having i=2) to hexagon H3 (having i=1). Therefore, in this example, particle 805 is determined to have deviated from the expected path, and a value of i=−2 is stored in association with particle 805 in the state space.

### Heading Information

The intended path information not only provided improved position information, but also provides improved heading information. In a particularly advantageous embodiment, the heading of the particles is used to improve the accuracy and reliability of the position estimates.

If the user is following the intended path, then it is likely that they are heading in a direction that is approximately parallel to the intended path. A modification to the above described methods will now be described in which particles that are on the intended path and heading in an expected direction are given a weight increase, in addition to an increase due to being on the intended path, resulting in more particles that follow the intended path heading.

As described above, the sensors present in a smartphone are susceptible to heading errors which can be difficult to correct. After a number of timestamps, a heading error can become a position error as the true path and the particle paths diverge, so there is significant benefit in correcting heading errors when a particle seems to be following the intended path. Accurate heading information can also be an important output from the particle filter (for example, to be able to provide turn-by-turn directions to the user).

In this example, the state vector comprises position and heading information. The stored data that represents the intended path is modified by associating a heading angle with each polygon along the intended path. This angle is the intended path heading. If a particle is within a polygon on the intended path and the particle's heading angle is within a threshold angular range of the intended path heading for the current polygon, then the particle's heading is determined to be consistent with the intended path. The state vector is augmented with a heading weight flag, which in this example is a binary (0 or 1) variable. The heading weight flag is set to zero in the initialization step. During the forward propagation step, the heading weight flag is propagated forwards unchanged.

The weight update step is augmented by increasing the weight by a predetermined factor for each particle that is observed to have a heading that is close to the heading angle for its current polygon. For each particle on the intended path, its heading corresponding to its most recent step is recorded. If the recorded heading is consistent with the intended path, then the weight of that particle is increased by a predetermined factor, the ‘heading weight’. In this example, this increase is applied only if the heading weight flag for that particle is not set, when the particle heading is first observed to match the intended path heading (although this need not necessarily be the case). After the heading weight is applied a flag is set, and if the flag is set then the increase is not applied again. However, the flag is reset if the particle moves to a later polygon on the intended path. If the particle is then found to be heading in a direction consistent with the new polygon, then the heading weight factor is applied again.

If the particle is not on the intended path, then the increase in weight for each particle that is observed to have a heading that is close to the heading angle for its current polygon is not applied.

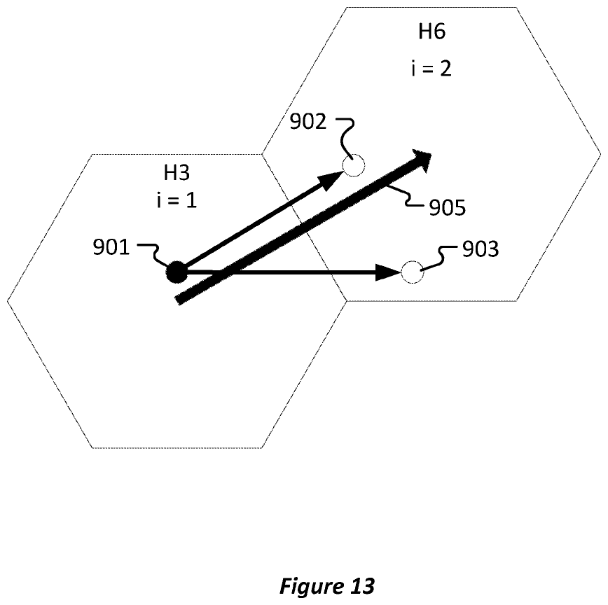

FIG. 13 is a simplified schematic illustration of two particles that are located along the intended path, but have different headings. The particles were initially located at a position indicated by the solid black particle 901. Both of the particles have moved, along the intended path, from hexagon H3 (i=1) to hexagon H6 (i=2). The arrow 905 indicates an expected heading from hexagon H3 to hexagon H6 along the intended path. As can be seen in the figure, particle 902 has moved along a heading that is generally parallel to the expected heading. In contrast, particle 903 has deviated from the expected heading. In this example, the heading of particle 902 lies within a predetermined angular range of headings around the heading 905 associated with the intended path. Therefore, the weight associated with particle 902 is increased using the heading weight factor. The heading of particle 903 lies outside of a predetermined angular range of headings around the heading 905 associated with the intended path, and therefore the heading weight factor is not applied to particle 903.

### Exemplary Intended Path

In some of the above described figures, the intended path has been represented using a sequence of contiguous hexagons of equal size. However, it will be appreciated that any other suitable shape or set of shapes may be used to define the intended path (and the other areas that do not form part of the intended path).

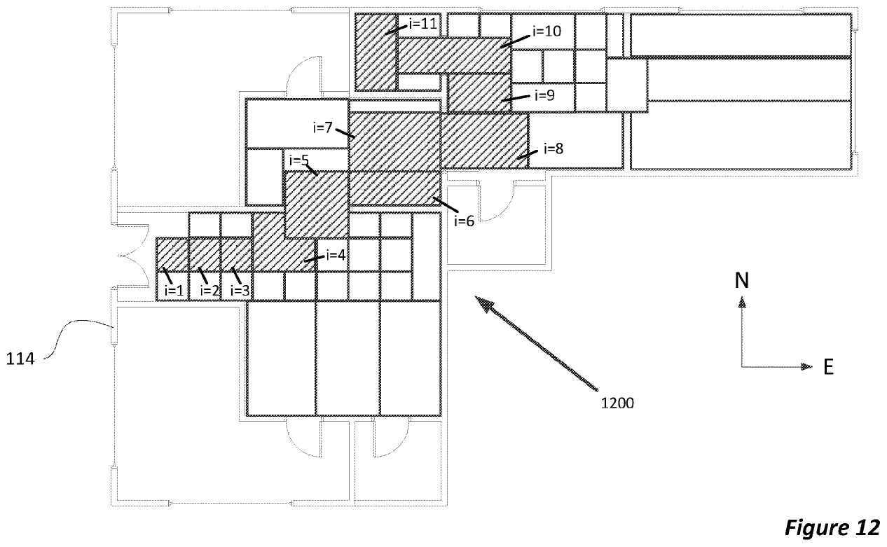

FIG. 12 schematically illustrates an example of an intended path through the building of FIG. 2 that is represented by a set of areas of differing shape and size. In the figure, the intended path corresponds to the diagonally shaded areas labelled from i=1 to i=11. As illustrated in the figure, since the rooms of a building are typically of rectangular shape, squares or rectangles may be a particularly efficient way of dividing the rooms into logical areas for mapping the intended path.

### Modifications and Alternatives

An exemplary position estimation system and associated apparatus and methods have been described above in detail. As those skilled in the art will appreciate, a number of modifications and alternatives can be made to the above examples and variations whilst still benefiting from the inventions embodied therein.

The polygons may be numbered using identifiers based on the order of the polygons along intended path (for example, hexagons H3, H6 H9 and H8 of FIG. 7 may instead be labelled H1, H2, H3 and H4, respectively), in which case the separate value of i need not necessarily be stored in the data storage 323.

Whilst in some examples described above the portable user device has been described as performing the method of generating the estimated location of the user device, alternatively the method may be performed by any other suitable apparatus in communication with the portable user device. For example, sensor data obtained by the portable device may be transmitted to a remote server (or servers), and the remote server may be configured to perform all (or some) of the above-described steps for determining the estimated location of the user device. The estimated location could then be transmitted from the remote server to the portable user device (for example, over a wireless internet connection).

Whilst in some examples described above the method of determining an estimated location of the device has been described as comprising a particle filter method, it will be appreciated that this need not necessarily be the case. For example, a Gaussian Mixture PHD filter, which represents a probability distribution of where the device may be located using a mixture of Gaussian distributions, could be used. It will be appreciated, therefore, that advantages of the invention are nevertheless obtained even when the particle filter method is not used. For example, the advantages of using the expected path of the device to determine a more accurate estimate of the location of the device are obtained even when, for example, a Gaussian Mixture PHD filter is used instead of the particle filter method.

It will be appreciated that the above described state information need not necessarily include all of the above-described parameters (for example, the error parameters may be omitted). In one example, the state information simply comprises the particle coordinates (e.g., x, y, and optionally z), velocity and intended path information (e.g. the integer i). In another example the state information simply comprises the particle coordinates (e.g., x, y, and optionally z), velocity, heading information and intended path information (integer i).

In the above description, the data sources 320 and processing unit 330 have been described for ease of understanding as comprising a number of discrete modules. However, it will be appreciated that the functionality performed by part or all of the software may be performed using one or more dedicated hardware circuits for example using one or more dedicated integrated circuits such as an application specific integrated circuit (ASIC) or the like. The use of software modules is, nevertheless, preferred as it facilitates the updating of the system.

It will be appreciated that the processing unit 330 referred to in the above description may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

The location tracking device may be a stand-alone dedicated tracking device or may be integrated as part of another device. For example, the location tracking device may form part of a mobile communications device such as a mobile (cellular) telephone, personal digital assistant, laptop, notebook, tablet computer, and/or the like.

### Wall Handling as Part of Forward Model

It will be appreciated that, whilst wall handling is described in terms of a weight update procedure, wall handling could be provided as part of the forward model. The implementation of wall handling as part of the forward model may, for example, involve: performing the forward model step; if a particle is found to go through a wall as part of the forward model step re-sampling the particle again; and repeating until the particle no-longer passes through a wall.

### Modelling Satellite Offset

Errors in the position reported by satellite positioning systems such as GPS data are known to contain systematic offsets of up to dozens of meters which can persist over long time periods. Such errors can be more difficult to identify than random fluctuations. Increasing the measurement noise of a satellite measurement may alleviate this problem as this effectively tells the algorithm to trust the satellite data less.

A more sophisticated approach to alleviate this noise source may be employed which takes advantage of the fact that satellite errors are known to be time-correlated. Specifically, the device 112 may be improved by the use of two additional dimensions in the system state, to take account of satellite offset errors, and to allow the time-correlated satellite errors to be taken into account. This effectively incorporates additional states into the particle filter to represent satellite offset error in the same way that step length error and heading error are handled.

### Include Position Component of Resampling Jitter

Whilst, in some of the above described examples the location components (x, y) of the system state are not jittered, in order to avoid performing wall-handling multiple times for a one time step, it will be appreciated that they may be jittered if particularly high performance is needed. Nevertheless, accurately estimating the main error sources generally has a larger impact on performance than small positional variations and so performance is not significantly degraded, for most applications, by not jittering the position.

Various other modifications will be apparent to those skilled in the art and will not be described in further detail here.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

1. A method of estimating a location of a device, the method comprising:
obtaining information indicating an initial location of the device;
obtaining data indicating a movement of the device;
obtaining information corresponding to an expected path of the device;
determining, using the data indicating the movement of the device, a set of candidate locations of the device, and assigning each candidate location a corresponding weight using the information corresponding to the expected path of the device; and
determining an estimated location of the device using the set of candidate locations and the corresponding weights.

2. The method according to claim 1, wherein the method further comprises:
iteratively updating the set of candidate locations and the corresponding weights; and
updating the estimated location of the device using the updated set of candidate locations and the corresponding weights.

3. The method according to any preceding claim, further comprising reducing the weight of a candidate location that corresponds to the device departing from the expected path.

4. The method according to any one of claims 1 to 3, wherein the method further comprises obtaining mapping data that indicates a plurality of spatial zones; and
wherein the information corresponding to the expected path of the device indicates a sequence of the spatial zones that corresponds to at least part of the expected path.

5. The method according to claim 4, wherein the sequence of spatial zones is a contiguous sequence of spatial zones.

6. The method according to claim 4 or 5, wherein the mapping data includes, for each of the spatial zones in the sequence, a corresponding sequence identifier that identifies the position of the spatial zone in the sequence.

7. The method according to claim 6, wherein the method further comprises:
storing, when a candidate location falls within a spatial zone of the sequence, that candidate location in association with the corresponding sequence identifier of that spatial zone.

8. The method according to any one of claims 4 to 7, wherein the method further comprises:
storing, when a candidate location corresponds to the device leaving the expected path from a spatial zone in the sequence, information identifying the spatial zone from which the device left the path, in association with the candidate location.

9. The method according to any one of claims 4 to 8, wherein the mapping data comprises:
for at least some of the spatial zones, a corresponding weighting factor for reducing or increasing the weight of a candidate location that corresponds to the device moving into that spatial zone.

10. The method according to any one of claims 4 to 9, wherein the mapping data comprises:
for at least one of the spatial zones, a corresponding weighting factor for reducing the weight of a candidate location that corresponds to the device departing the expected path by moving out of that spatial zone; or
for at least one of the spatial zones, a corresponding weighting factor for reducing the weight of a candidate location that corresponds to the device departing the expected path by moving into that spatial zone.

11. The method according to any preceding claim; wherein the method further comprises reducing the weight of a candidate location that corresponds to the device departing the expected path using a global weighting parameter.

12. The method according to any one of claims 6 to 11, wherein the method further comprises:
reducing the weight of a candidate location that corresponds to the device moving from a first spatial zone of the spatial zones that form the expect path to a second spatial zone of the spatial zones that form the expected path, when a difference between the sequence identifier stored in association with the first spatial zone and the sequence identifier stored in association with the second spatial zone exceeds a predetermined threshold value.

13. The method according to any preceding claim, wherein the method further comprises increasing the weight of a candidate location that corresponds to the device re-joining the expected path.

14. The method according to any preceding claim, wherein the method further comprises:
obtaining information indicating the location of walls of a building;
determining whether a candidate location corresponds to the device moving through a wall of the building; and
reducing the weight of a candidate location that corresponds to the device moving through a wall of the building.

15. The method according to any preceding claim, wherein the information indicating a movement of the device includes data obtained from at least one sensor of the device.

16. The method according to claim 15, wherein the information indicating a movement of the device includes data obtained from a gyroscope, accelerometer, magnetometer, or pressure sensor of the device.

17. The method according to any preceding claim, wherein the method further comprises using the estimated location of the device for guided navigation along the expected route.

18. The method according to any preceding claim, wherein the method further comprises:
obtaining information corresponding to an expected heading of the device; and
determining the weights using the information corresponding to the expected heading of the device.

19. The method according to claim 18, wherein the method further comprises:
increasing the weight of candidate locations that correspond to the device having a heading that is within a predetermined angular range of the expected heading; or
decreasing the weight of candidate locations that correspond to the device having a heading that is not within a predetermined angular range of the expected heading.

20. The method according to any preceding claim, wherein the method of estimating the location of the device comprises a particle filter method.

21. The method according to any preceding claim, wherein the method of estimating the location of the device comprises a sequential Monte Carlo method.

22. The method according to any preceding claim, wherein the method further comprises:
obtaining user characteristic information indicating a step length or step frequency of the user; and
determining the candidate locations using the obtained user characteristic information.

23. A computer-readable medium comprising instructions which, when executed by a computer, cause the computer to carry out the method of any preceding claim.

24. Apparatus for estimating a location of a device, wherein the apparatus comprises:
means for obtaining information indicating an initial location of the device;
means for obtaining data indicating a movement of the device;
means for obtaining information corresponding to an expected path of the device;
means for determining, using the data indicating the movement of the device, a set of candidate locations of the device, and for assigning each candidate location a corresponding weight using the information corresponding to the expected path of the device; and
means for determining an estimated location of the device using the set of candidate locations and the corresponding weights.
